(19) United States
(12) Patent Application Publication
(10) Pub. No.: US 2003/0135535 A1
(43) Pub. Date: Jul. 17, 2003

(54) Transferring data between threads in a multiprocessing computer system

(76) Inventors: Jay P. Hoeflinger, Urbana, IL (US); Sanjiv M. Shah, Champaign, IL (US); Paul M. Petersen, Champaign, IL (US); David K. Poulsen, Champaign, IL (US)

Correspondence Address: Timothy N. Trop, TROP, PRUNER & HU, P.C., STE 100, 8554 KATY FWY, HOUSTON, TX, 77024-1805, US

(21) Appl. No.: 10/044,614

(22) Filed: Jan. 11, 2002

(51) Int. Cl. G06F 9/00

(52) U.S. Cl. 709/102; 709/107

(57) ABSTRACT

In some embodiments of the present invention, a parallel computer system provides a plurality of threads that execute code structures. A method and apparatus may be provided to copy data from one thread to another thread.

### FIELD OF THE INVENTION

The invention relates to the field of computer processing and more specifically to a method and apparatus for parallel multiple threads operating in a parallel computing process.

### BACKGROUND OF THE INVENTION

In order to achieve high performance execution of difficult and complex programs, scientists, engineers, and independent software vendors have turned to parallel processing computers and applications. Parallel processing computers typically use multiple processors to execute programs in a parallel fashion that typically produces results faster than if the programs were executed on a single processor.

In order to focus industry research and development, a number of companies and groups have banded together to form industry-sponsored consortiums to advance or promote certain standards relating to parallel processing. OpenMP Fortran Application Program Interface Version 2.0 (“OpenMP”) is one such standard that has been developed. OpenMP is a specification for programming shared memory computers (SMP).

The OpenMP specification includes a number of directives and clauses that indicate to an OpenMP compiler how particular codes should be compiled. The manner in which these directives and clauses are compiled by a compiler meeting the OpenMP specification is determined by the designers of the compiler. Often, these directives and clauses may be implemented with low-level code such as assembly or object code that is designed to run on specific computing machines. This may result in considerable programming effort being expended to support a particular directive or clause across a number of computing platforms.

One particularly useful OpenMP clause is the “copyprivate” clause. This clause may be used in a number of ways one of which is to implement a “gather-scatter” type of data broadcast. The gather-scatter data broadcast typically refers to a programming structure that gathers data from a number of different sources and consolidates that data into a single location.

The consolidated data may then be scattered to a number of different locations at a later time. The gather-scatter concept may be particularly useful in parallel processing where multiple threads may need data that is stored in the private memory area of a producer thread. In this situation, the data must be gathered from its various locations in the producer thread's private memory areas and then copied by the parallel threads to locations in their private memory areas.

What is needed therefore is a method and apparatus that may implement a copyprivate clause that may be efficient and may be cost effectively implemented over multiple computer platforms.

### BRIEF DESCRIPTION OF THE DRAWINGS

FIG. 1 is a schematic depiction of a processor-based system in accordance with one embodiment of the present invention.

FIG. 2 illustrates a data -flow diagram for the generation of executable code according to embodiments of the present invention.

FIG. 3 is a simplified flow chart of a parallel computing program that may use a copyprivate clause.

FIG. 4 is a flowchart of an exemplary parallel processing program utilizing a copyprivate clause according to some embodiments of the present invention.

FIG. 5 is a flowchart of a program translated from the program of FIG. 4 according to some embodiments of the present invention.

FIG. 6 is a flowchart of a runtime library according to some embodiments of the present invention.

FIG. 7 is a flowchart of a data copying program according to some embodiments of the present invention.

FIG. 8 is a graphical depiction of a descriptor according to some embodiments of the present invention.

### DETAILED DESCRIPTION

In the following description, numerous specific details are set forth to provide a detailed understanding of the present invention. However, one skilled in the art will readily appreciate that the present invention may be practiced without these specific details. For example, the described code segments may be consistent with versions of the Fortran programming language. This however is by way of example and not by way of limitation as other programming languages and structures may be similarly utilized.

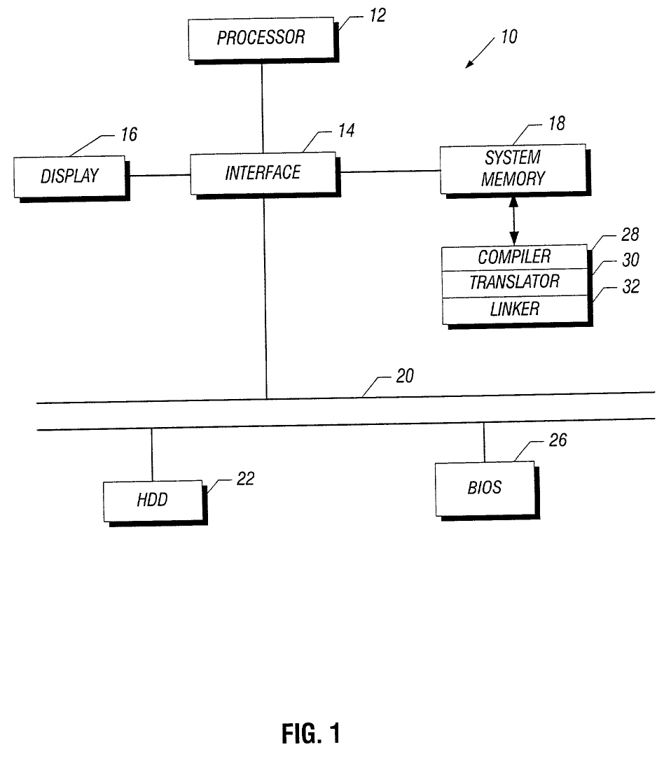

Referring to FIG. 1, a processor-based system 10 may include a processor 12 coupled to an interface 14. The interface 14, which may be a bridge, may be coupled to a display 16 or a display controller (not shown) and a system memory 18. The interface 14 may also be coupled to one or more busses 20. The bus 20, in turn, may be coupled to one or more devices 22, such as a hard disk drive (HDD). The hard disk drive 22 may store a variety of software, including source programming code (not shown), compiler 28, a translater 30, and a linker 32. A basic input/output system (BIOS) memory 26 may also be coupled to the bus 20 in one embodiment. Of course, a wide variety of other processor-based system architectures may be utilized.

In some embodiments, the compiler 28, translater 30 and linker 32 may be stored on hard disk 22 and subsequently, loaded into system memory 18. The processor 12 may then execute instructions that cause the compiler 28, translator 30 and linker 32 to operate.

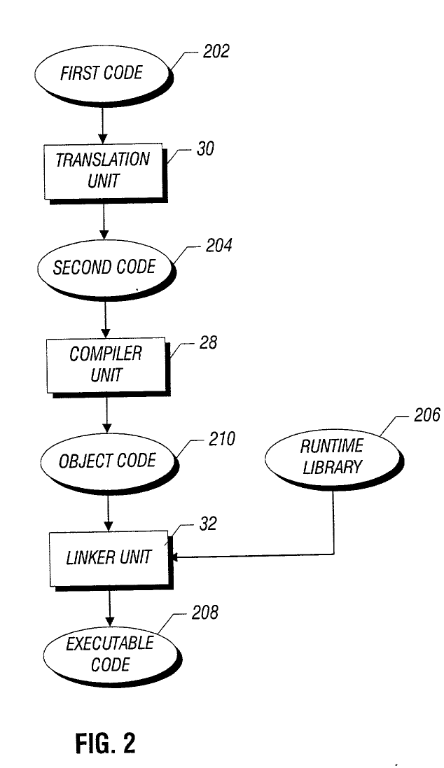

Referring now to FIG. 2, a first code 202 may be a source program that may be written in a programming language.

When written in source code, the first code 202 may be considered to be in source code format. A few examples of programming languages are Fortran 90, Fortran 95 and C++. The first code 202 may be a source program that may have been converted to parallel form by annotating a corresponding sequential computer programming with directives according to a parallelism specification such as OpenMP. In other embodiments, the first code may have been coded in parallel form in the first instance.

These directives may designate parallel regions of execution that may be executed by one or more threads, single regions that may be executed by a single thread, and instructions on how various program variables should be treated in the parallel and single regions. The parallelism specification in some embodiments, may also comprise a set of clauses such as the clause “copyprivate” that will be explained in more detail below.

In some embodiments, parallel regions may execute on different threads that run on different physical processors in the parallel computer system, with one thread per processor. However, in other embodiments, multiple threads may execute on a single processor.

In some embodiments, the first code 202 may be read into a code translator 30. The translator 30 may perform a source-code-to-source-code level transformation of OpenMP parallelization directives in the first code 202 to generate, in some embodiments, Fortran 95 source code in the second code 204. However, as previously mentioned, other programming languages may be utilized.

The compiler 28 may receive the second code 204 and may generate an object code 210. The compiler 28 may be different compilers for different operating systems and/or different hardware. In some embodiments, the compiler 28 may generate object code 210 that may be executed on Intel® processors.

Linker 32 may receive object code 210 and various routines and functions from a run-time library 206 and link them together to generate executable code 208.

In some embodiments, the run-time library 206 may contain subroutines that the linker may include to support the copyprivate clause.

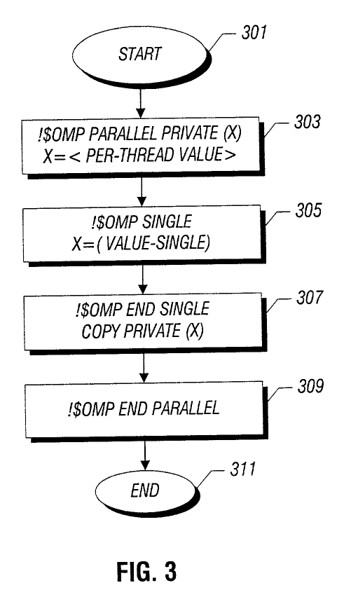

Referring to FIG. 3, a number of code blocks are detailed that represent a simplified Fortran source-code program. The program may start at block 301 and begin executing a first directive 303 that may specify, in some embodiments, that all threads operating in a parallel region, that may be between blocks 303 and 309, should perform the assignment function “X=(per-thread value)”. This may cause each thread to assign its private variable “X” a particular value. Each thread may have a private memory area in which it may store private variables.

The “single” directive in block 305 may cause only a single thread to execute the instruction “X=(value-single)”. This assignment may supply the variable X with a particular value that was established by the single thread. The thread that is designated “single” may be arbitrarily chosen. For example, the single thread may be the first thread to begin executing the single directive.

The “end single copyprivate” instruction in block 307 is a directive (end single) that may specify the end of a single region and a clause (copyprivate) for the single thread to copy its private value of “X” to other threads operating within the parallel region 303 to 309.

In some embodiments, only one thread, the single thread, executes the instructions between blocks 305 and 307 while other parallel threads may wait at block 307 until the single thread executing code in blocks 305 and 307 is finished. In one embodiment, once the single thread has executed the instructions in block 307, the single thread may wait at block 307 (enter a wait state) until the other parallel threads that may be waiting at block 307 exit block 307. In one embodiment, once the other parallel threads have all exited the directive in block 307, the single thread may continue and all threads may execute the instructions in block 309 (end Parallel). The program may end at block 311.

As will be described in detail below, the copyprivate clause in block 307, in some embodiments, may provide a mechanism for the single thread to broadcast or scatter its particular “X” value to the other threads that may be operating within the parallel region, blocks 303-309.

In some embodiments, the copyprivate clause may use a descriptor to broadcast a variable, or a pointer to a shared object, from one member of a team of parallel threads to other members of the team of threads. This clause may provide an alternative to using a shared variable for transferring a value, or pointer association, and may be useful when providing such a shared variable would be difficult (for example, in a recursion requiring a different variable at each level).

The copyprivate clause may appear on the “end single” directive in a Fortran program. In other computer languages it may appear at different locations. In some embodiments, the copyprivate clause may have the following format:

Copyprivate (List)

The effect of the copyprivate clause on the variables in its list may occur after the execution of the code enclosed within the single code construct, 305-307, and before any threads have left the barrier at the end of the single construct, 307. If the variable is not a pointer, then in other threads in the team of parallel threads, that variable may become defined (as if by assignment) with the value of the corresponding variable in the thread that executed the single construct code, 305-307. If the variable is a Fortran pointer, then in other threads in the team, that variable may become a pointer associated (as if by pointer assignment) with the corresponding variable in the thread that executed the code in the single code construct, 305-307.

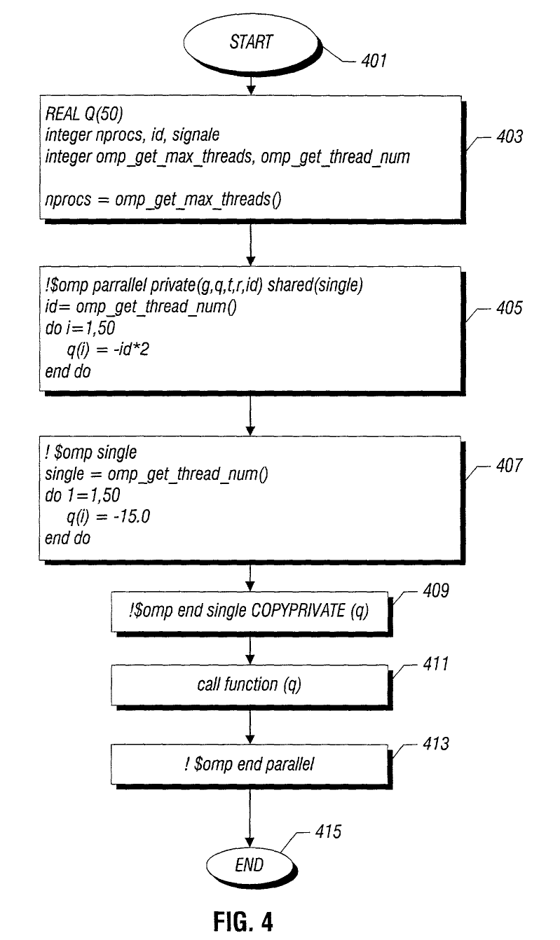

Referring to FIG. 4, a source code program may start at code block 401 and begin executing instructions in block 403. Instructions in block 403, in some embodiments, may include initialization instructions and an instruction that may cause the computer executing this code to fork (start) parallel executing threads.

The parallel threads started in block 403 may begin executing the instructions in block 405. These instructions may take many forms including, as one example, the instructions in block 405. Once the parallel threads have executed the instructions in block 405, they may begin executing the “single” directive (!$OMP single) in block 407. This directive as previously discussed, may prevent all but one thread from executing the code within the single region that may include blocks 407 and 409.

In some embodiments, the first thread that starts to execute the single directive becomes the single thread that may execute the code within the single construct, blocks 407 and 409. In one embodiment, other threads may skip over the instructions in block 407 and may wait (enter a wait state) at block 409 for the single thread to complete executing the code in the single region 407-409. In some embodiments, the “end single copyprivate” directive and clause in block 409 may be a barrier for the parallel threads other than the single thread.

The single thread, in this example, may set array elements Q(I) to equal a value (−15.0). However, the instructions within the single construct, blocks 407 and 409, may be any number of different instructions. In some embodiments, once the single thread finishes executing instructions in block 407, it may begin executing the “copyprivate (Q)” clause in block 409. This clause may cause each parallel thread including the single thread to each build a descriptor that may contain the address and length of its private variable Q. The single thread may then post the address of its descriptor at a known location. Then, in some embodiments, the other threads that are operating within the parallel construct, blocks 405-413, may use the posted address to locate the single thread's descriptor and to copy the single thread's version of Q to a location described in their own descriptors that may be in their private memory areas. In some embodiments, the known location may be an active buffer.

In block 413, the instruction “!$OMP end parallel” may terminate parallel thread execution and the program may end at block 415.

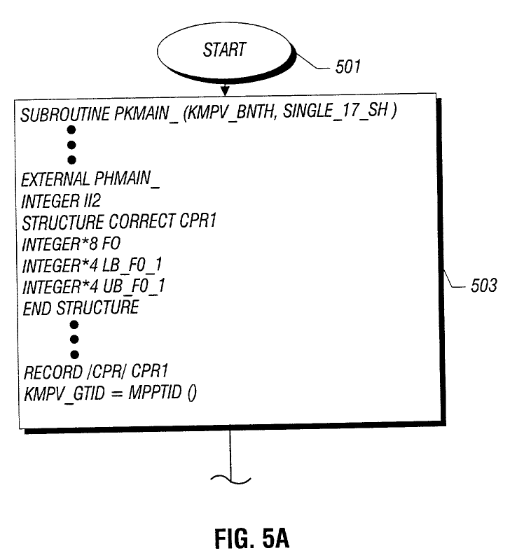

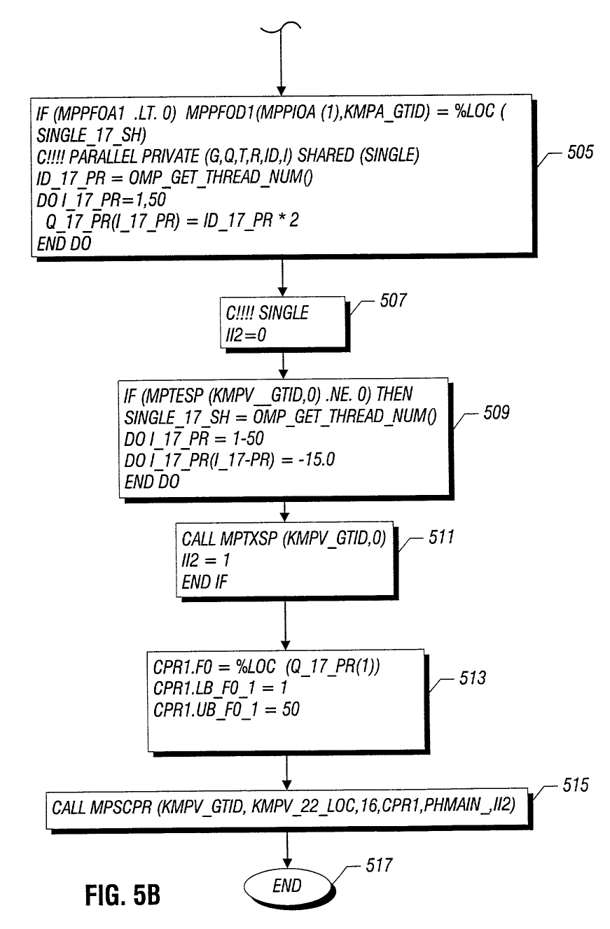

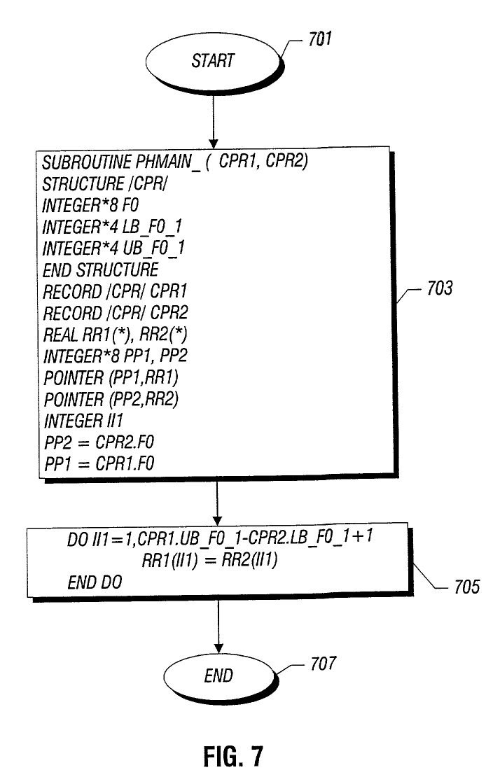

In one embodiment of the present invention, the source code, 403-413, may be a first code and may be translated by the translator 30 into a second code a part of which may be depicted in FIGS. 5A, 5B and 7. The translator 30 may have translated the first code using a source-code-to-source-code translation.

Referring to FIG. 5A and 5B, a subroutine that may be arbitrarily named PKMAIN may start at block 501 and, in one embodiment, include header and initialization code which may be executed in block 503. The header and initialization code may be specific to a particular computing environment. The code in block 505 may be a translation of the code in block 405 and may function as was discussed in association with block 405 of FIG. 4. The instruction “II2=0” in Block 507 may cause all the parallel threads to set their private variable II2 to equal 0. This may provide a flag at a later point in the code execution.

The single thread may execute the instructions in block 509 that may be generally as described in association with block 407 of FIG. 4. At block 511, the single thread may set its value of the variable II2 to equal “1”. This may later provide a flag to identify which thread was the single thread as the single thread may have its variable II2 set to “1” and all other threads may have their II2 variable set to “0”.

Threads other than the single thread may not execute the instructions in blocks 509 and 511 and may skip over these blocks of code. In one embodiment, the “IF” statement in block 509 tests true for only the single thread and therefore, only the single thread may execute the instructions in blocks 509 and 511.

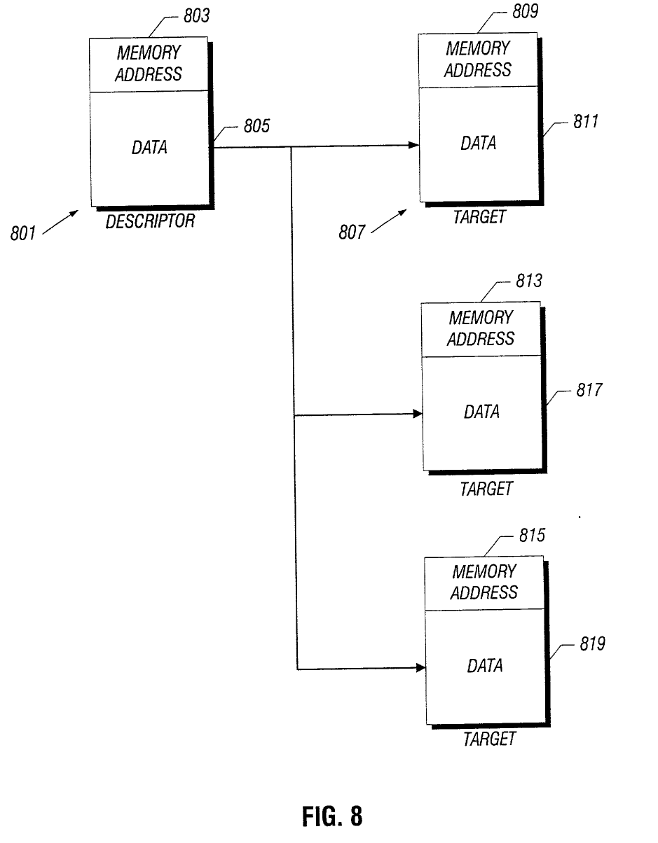

In some embodiments, the parallel threads may execute the instructions in block 513. These instructions, in some embodiments, may cause the parallel threads to set up descriptors such as 801 in FIG. 8, and may specify upper and lower bounds of a private array to be copier. In block 513, “CPR1.F0” may indicate a base address for the private array while “CPR1.LB_F0_{—}1” may indicate a lower bound and “CPR1.UB_F0_{—}1” may indicate an upper bound of the private array.

In some embodiments, after the parallel threads have established their descriptors in block 513, they may call a subroutine that may be arbitrarily named “MPSCPR” in block 515. In some embodiments, this “call MPSCPR” instruction at block 515 may pass a number of variables to the subroutine MPSCPR that may execute the copy routines necessary to support the copyprivate clause by, in one embodiment, copying data from the single thread's memory area to other parallel threads' memory areas. The descriptors may define where to copy data from and where to copy data to in memory areas.

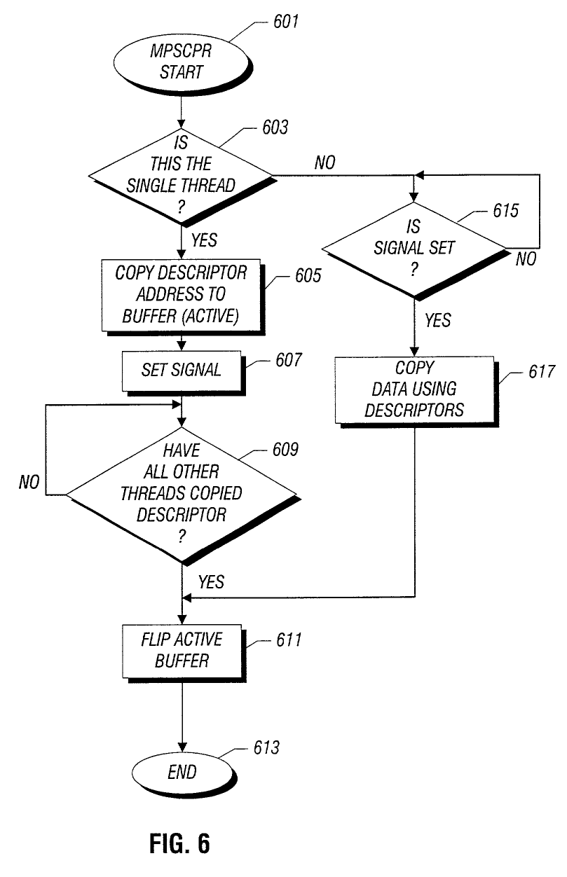

Referring to FIG. 6, the subroutine program MPSCPR may begin at block 601. At decision block 603, a determination may be made whether the thread currently executing the code is the single thread or another parallel thread. In some embodiments, this may be ascertained by examining the value of the variable II2. The single thread as mentioned above may have variable II2 set to “1” while the other threads may have their copy of variable II2 set to equal “0”. However, other mechanisms may be utilized to determine the single thread from other threads.

If the thread at decision block 603 is the single thread, the single thread may execute the instructions in block 605. In some embodiments, this may be done by copying the address of the single thread's descriptor to an active buffer.

The single thread may then execute the instruction at block 607 that may set a signal that may indicate to other threads that the single thread has copied its descriptor address into an active buffer. Then in some embodiments, the single thread may execute the process decision block 609 and may wait (enter a wait state) until other parallel threads have used the single thread's descriptor address to copy the data to their own private memory area. In some embodiments, the process decision block 609 may become a barrier for the single thread.

In some embodiments, the buffer may be a two-address buffer. For a particular copyprivate operation, the threads each may have pointers that may point to the same one of the two addresses. The address pointed to may be the active buffer for that operation. After a particular thread completes its portion of the copyprivate operation, it may switch its pointer to the other address. While a two-address buffer may be advantageous, other size buffers may also be utilized.

In some embodiments, as each thread exits the MPSCPR code, it executes the instruction in block 611. This instruction, block 611, in some embodiments, may cause the thread to switch its pointer from the active buffer that may have been used in block 605, to point to a second buffer. The use of multiple buffers may be required in some embodiments to allow multiple single threads in unrelated portions of code to share the MPSCPR code.

If at process decision block 603 the thread currently executing the code is not the single thread, the thread may enter a process decision block 615 where it may determine, in some embodiments, whether the signal has been set in block 607 by the single thread. If the signal is not set, then the thread may continue to wait (enter a wait state) until the single thread sets the signal at block 607.

In some embodiments, after the signal is set by the single thread at block 607, the other parallel threads may execute the instructions in block 617. As was previously described in association with block 605, the other parallel threads may use the single thread's descriptor to copy the single thread's data into the other parallel threads' private memory area, as described by the other parallel threads' descriptors. In some embodiments, this may be done by using a subroutine such as PHMAIN (FIG. 7) or another code block that may copy the data.

In some embodiments, after the other parallel threads may have executed the code in block 611 to switch to a different active buffer, they may exit the MPSCPR routine at block 613. Block 613 may be a return instruction that returns execution to another code block that may be active in the computer system 10.

The code block MPSCPR (blocks 601-613) may be part of a run-time library routine. This run-time library routine may be written in source code, object code, intermediate code or other code that may be executed on the computer system 10. However, in other embodiments, the function performed by the routine MPSCPR may be part of a source code routine or other code block and may not be part of a run-time library.

Referring to FIG. 7, the subroutine (PHMAIN) may in some embodiments, perform a copy function as previously described. This program may start at block 701, and when executed, the program may perform certain initialization routines and execute certain instructions such as in block 703.

Of course, other initialization routines and instructions may also be performed in addition to or in place of those detailed in block 703. The program may then execute the instructions in block 705 which may in some embodiments copy data from one memory area to another memory area that may be designated as arrays “RR2” and “RR1” respectively.

In one embodiment, after the instructions in block 705 are performed, the routine may end at block 707 that may be a return from subroutine instruction that may cause execution to return to another area in the memory 18 or some other memory area.

Referring to FIG. 8, a descriptor 801 includes, in some embodiments, a memory address 803 and a data area 805. A target 807 may include a memory address 809 and a data area 811. As was described previously, the descriptor 801 may provide information about the location, 809, 813 and 815, and size of one or more data areas 811, 817 and 819. The data area 811 may hold a single variable or may hold, in some embodiments multiple variables, such as may be required to store a data array.

Any of the source code 202, second code 204, object code 210, run-time library 206, and executable code 208 may be stored in a memory device that may include system memory 18, a disk drive such as hard disk drive 22 or other memory device on which a set of instructions (i.e., software) may be stored. The software may reside, completely or at least partially, within this memory and/or within the processor 12 or other devices that may be part of the computer system 10.

For the purposes of this specification, the term “machine-readable medium” shall be taken to include any mechanism that provides (i.e., stores and/or transmits) information in a form readable by a machine such as a computer. Examples of such machine-readable mediums include by way of example and not limitation, read only memories (ROM), random access memory (RAM), magnetic disk storage media, optical storage media, flash memory devices, or other such devices.

Embodiments of the invention may provide efficient, scalable, copy operations. A single instantiation of the present embodiments of the invention may implement efficient copy operations across multiple platforms (i.e., variants of hardware architecture, operating system, threading environment, compilers and programming tools, utility software, etc.) and yet optimize performance for each individual platform.

The present embodiments of the invention may provide for using low-level instruction sets to support thread-to-thread memory copy operations on an individual platform in order to optimize performance on that platform, while still providing the ability to optimize performance separately on other platforms. For example, in some embodiments, a runtime library routine, may be optimized for a particular computer platform to perform part of the copy operation. This optimization may be performed utilizing low-level code of which assembly code and object code are two examples.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a first program unit in a parallel computing environment having a team of parallel threads including at least a first and second thread, the first program unit including a memory copy operation to be performed between the first thread and the second thread; and
translating the first program unit into a second program unit, the second program unit to associate the memory copy operation with a set of one or more instructions, the set of instructions to ensure that the second thread copies data based, in part, on a first descriptor associated with the first thread.

2. The method of claim 1 further comprising copying the address of the first descriptor to a buffer and copying data into a memory area associated with the second thread based, in part, on address and data information associated with the first descriptor.

3. The method of claim 2 further comprising copying data into a memory area associated with second thread utilizing, in part, a second descriptor associated with the second thread.

4. The method of claim 1 further comprising enabling the first thread to copy an address of the first descriptor to a buffer and setting a signal to enable the second thread to copy data associated with the first descriptor to a memory area associated with the second thread.

5. The method of claim 4 further comprising enabling the first thread to enter a wait state after the signal is set.

6. The method of claim 5 further comprising releasing the first thread from a wait state upon completion of the data copy operation by the second thread.

7. The method of claim 5 further comprising enabling the first thread to copy an address of the first descriptor to one of two buffer areas.

8. The method of claim 1 further comprising receiving the first program unit in source code format and translating the first program unit into a second program unit in source code format.

9. A machine-readable medium that provides instructions, that when executed by a machine, enables the machine to perform operations comprising:
receiving a first program unit in a parallel computing environment, the first program unit including a memory copy operation to be performed between a first thread in a team of threads and a second thread in the team of threads; and
translating the first program unit into a second program unit, the second program unit to associate the memory copy operation with a set of one or more instructions, the set of instructions to ensure that the second thread copies data based, in part, on a first descriptor associated with the first thread.

10. The machine-readable medium of claim 9, further comprising copying the address of the first descriptor to a buffer and copying data into a memory area associated with the second thread based, in part, on address and data information associated with the first descriptor.

11. The machine-readable medium of claim 10, further comprising copying data into a memory area associated with second thread based utilizing, in part, a second descriptor associated with the second thread.

12. The machine-readable medium of claim 9, further comprising enabling the first thread to copy an address of the first descriptor to a buffer and setting a signal to enable the second thread to copy data associated with the first descriptor to a memory area associated with the second thread.

13. The machine-readable medium of claim 12, further comprising enabling the first thread to enter a wait state after the signal is set.

14. The machine-readable medium of claim 13, further comprising releasing the first thread from a wait state upon completion of the data copy operation by the second thread.

15. The machine-readable medium of claim 13, further comprising enabling the first thread to copy an address of the first descriptor to one of two buffer areas.

16. The machine-readable medium of claim 12, further comprising copying data into a memory area associated with second thread utilizing, in part, a second descriptor associated with the second thread.

17. The machine-readable medium of claim 9 further comprising receiving the first program unit in source code format and translating the first program unit into the second program unit in source code format.

18. A method comprising:
receiving a first program unit in a parallel computing environment and translating the first program unit, in part, into one or more computer instructions, the instructions enabling a second thread in a team of threads to copy data, into a memory area associated with the second thread, from a private memory area associated with a first thread; and
copying the address of a descriptor into a buffer utilized by the second thread, in part, to copy data from the memory area associated with the first thread.

19. The method of claim 18, further comprising creating a descriptor utilized, in part, by the second thread to copy data into the memory area associated with the second thread.

20. The method of claim 19, further comprising setting a signal by the first thread enabling the second thread to copy the data from the memory area associated with the first thread.

21. The method of claim 20, further comprising entering a wait state by the first thread until the second thread copies the data from the memory area associated with the first thread.

22. An apparatus comprising:
a memory including a shared memory location; and
a translation unit coupled with the memory, the translation unit operative to associate a first program unit, including a memory copy operation to be performed between a first thread in a team of threads and a second thread in the team of threads, with a set of one or more instructions, the set of instructions to ensure that the second thread copies data based, in part, on a first descriptor associated with the first thread.

23. The apparatus as in claim 22 wherein the address of the first descriptor is copied to a buffer by the first thread and the second thread copies data into a memory area associated with the second thread based, in part, on address and data information associated with the first descriptor.

24. The apparatus as in claim 23 wherein the second thread copies data into a memory area associated with the second thread utilizing, in part, a second descriptor associated with the second thread.

25. The apparatus as in claim 22 wherein the first thread copies an address of the first descriptor to a buffer and sets a signal to enable the second thread to copy data associated with the first descriptor to a memory area associated with the second thread.

26. The apparatus as in claim 25 wherein the first thread enters a wait state after the signal is set.

27. The apparatus of claim 26, wherein the first thread exits the wait state after completion of the data copy by the second thread.

28. The apparatus of claim 22 wherein the first program unit is in source code format.

29. The apparatus of claim 28 wherein the first descriptor is passed to the first program unit.

30. The apparatus as in claim 22 wherein the translation unit translates the first program unit, in part, into a second program unit in source code format and the second program unit includes the memory copy operation.
